(19) United States
(12) Patent Application Publication
(10) Pub. No.: US 2020/0028301 A1
(43) Pub. Date: Jan. 23, 2020

(54) CONNECTOR HOLDER AND ELECTRONIC APPARATUS EQUIPPED WITH THE SAME

(71) Applicant: SHARP KABUSHIKI KAISHA, Sakai City (JP)

(72) Inventor: SOHICHI TAKATA, Sakai City (JP)

(21) Appl. No.: 16/506,284

(22) Filed: Jul. 9, 2019

(30) Foreign Application Priority Data
Jul. 18, 2018 (JP) 2018-134874

(51) Int. Cl. H01R 13/639; G02B 6/36

(52) U.S. Cl. CPC H01R 13/639; G02B 6/36

(57) ABSTRACT

A connector holder detachably holds a connector. The connector holder includes a holder-side elastic locking portion and a bolder-side engagement portion. The holder-side elastic locking portion deforms elastically and thereby engages with a panel opening formed in a panel. The holder-side engagement portion is engaged by a connector-side elastic locking portion of a connector while the connector-side elastic locking portion deforms elastically.

### BACKGROUND

### 1. Field

The present disclosure relates to a connector holder for detachably holding a connector and to an electronic apparatus equipped with the connector holder.

### 2. Description of the Related Art

A known configuration used for mounting a connector onto a panel is that the panel has an opening formed therein and the connector has an elastic locking portion. The connector is mounted on the panel by inserting the connector into the panel opening and thereby causing the elastic locking portion to deform elastically and to engage with the edge of the opening of the panel.

When there is a change in shape or size of the connector and the changed connector does not match the opening of the panel, a holder may be required to enable the changed connector to be mounted on the panel.

A known holder for mounting a connector onto a panel is disclosed in Japanese Unexamined Patent Application Publication No. 2004-45622. In this disclosure, the connector is an optical adapter that does not have an elastic locking portion, and the holder is structured as a metal bracket that enables the optical adapter to be mounted on a panel. The optical adapter has engagement grooves, whereas the metal bracket has a link plate and a pair of side boards that engage with the engagement grooves and an elastic locking hook for fitting the metal bracket onto the panel. The metal bracket is first mounted on the optical adapter by engaging the engagement grooves with the link plate and the side boards, and subsequently, the metal bracket is mounted on the panel by engaging the elastic locking hook with the edge of the panel opening.

However, in the structure for mounting the optical adapter on the metal bracket according to Japanese Unexamined Patent Application Publication No. 2004-45622, the link plate and side boards of the metal bracket and the optical adapter having the engagement grooves are all formed as rigid bodies. Accordingly, if the engagement grooves do not engage with the link plate and side boards smoothly, any forceful engagement may result in deformation of the metal bracket. In this case, the elastic locking hook of the metal bracket also deforms, and the deforming elastic locking hook does not engage with the edge of the panel opening firmly and may lead to wobbling engagement.

Accordingly, it is desirable that a connector holder enable a connector to be reliably mounted on and fixed to a panel without causing damage or deformation of the connector and the connector holder even if the connector is not compatible in size or the like with a panel opening in which the connector is mounted.

### SUMMARY

According to an aspect of the disclosure, there is provided a connector holder for detachably holding a connector. The connector holder includes a holder-side elastic locking portion configured to deform elastically and thereby engage with a panel opening formed in a panel. The connector holder also includes a holder-side engagement portion configured to be engaged by a connector-side elastic locking portion of a connector while the connector-side elastic locking portion deforms elastically.

According to another aspect of the disclosure, there is provided an electronic apparatus that includes the connector holder configured as described above and a panel in which a panel opening is formed. In the electronic apparatus, the holder-side elastic locking portion of the connector holder deforms elastically and engages with the panel opening.

### BRIEF DESCRIPTION OF THE DRAWINGS

FIG. 1 is a perspective view illustrating a connector holder as viewed obliquely from above;

FIG. 2 is a perspective view illustrating the connector holder as viewed obliquely from below;

FIG. 3 is a perspective view illustrating a female connector as viewed obliquely from above;

FIG. 4 is a perspective view illustrating the female connector as viewed obliquely from below;

FIG. 5 is a perspective view illustrating a panel;

FIG. 6 is a perspective view illustrating a state in which the female connector is installed in a small panel-opening formed in a panel;

FIG. 7 is a perspective view illustrating a male connector;

FIG. 8 is a perspective view illustrating a state in which the connector holder is installed in a large panel-opening formed in a panel;

FIG. 9 is a perspective view illustrating a state in which the female connector is installed in the connector holder, as viewed obliquely from above; and

FIG. 10 is a perspective view illustrating a state in which the female connector is installed in the connector holder, as viewed obliquely from below.

### DESCRIPTION OF THE EMBODIMENTS

Embodiments according to the present disclosure will be described with reference to the drawings.

### First Embodiment

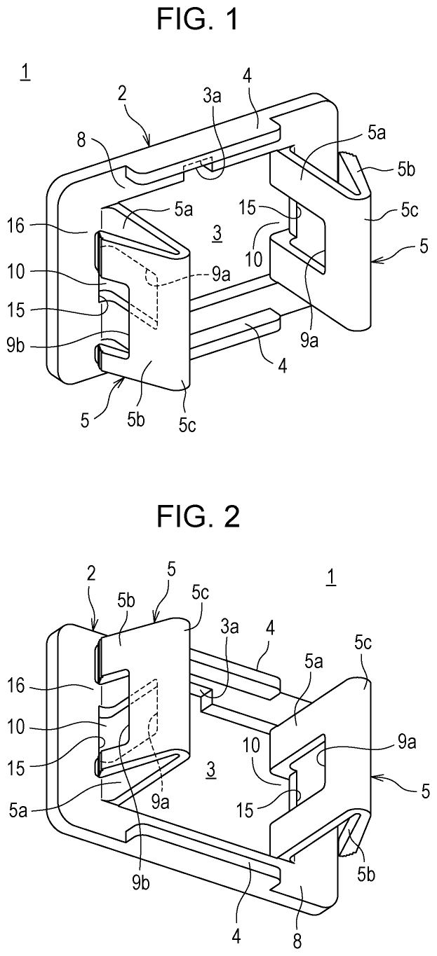

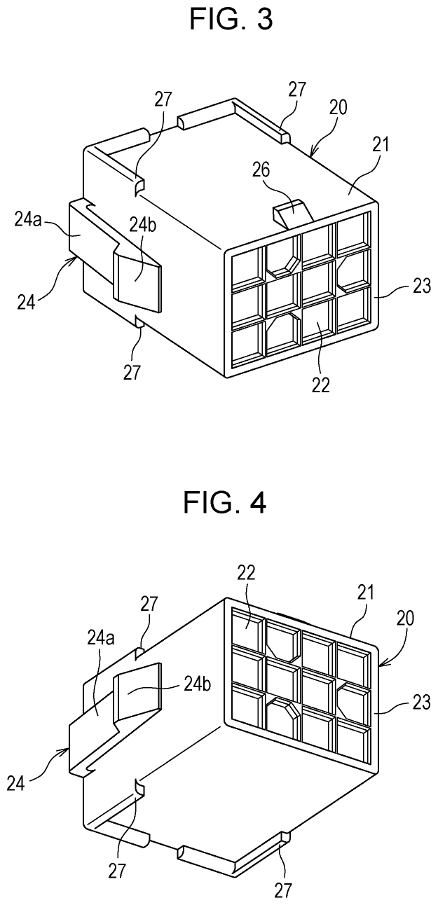

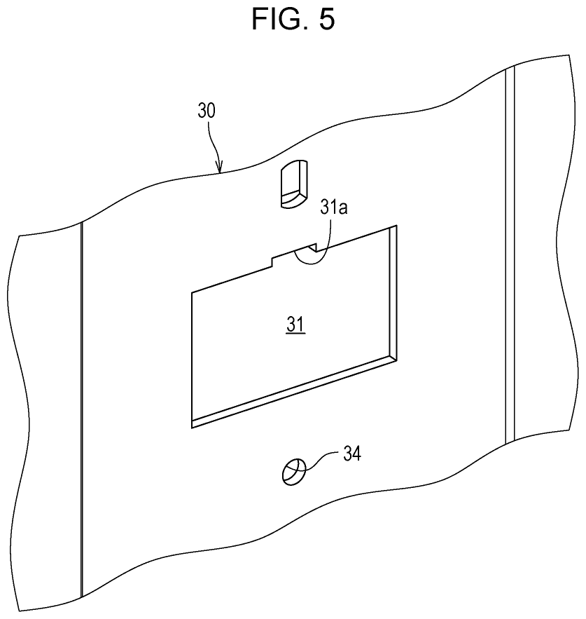

FIG. 1 is a perspective view illustrating a connector holder according to a first embodiment as viewed obliquely from above, and FIG. 2 is a perspective view illustrating the connector holder as viewed obliquely from below. FIG. 3 is a perspective view illustrating a female connector to be mounted on the connector holder as viewed obliquely from above, and FIG. 4 is a perspective view illustrating the female connector as viewed obliquely from below. FIG. 5 is a perspective view illustrating a panel on which the connector holder is to be mounted.

As illustrated in FIGS. 1 and 2, a connector holder 1 includes a quadrangularly shaped holder body 2, a quadrangularly shaped central opening 3 formed at the central portion of the holder body 2, a pair of abutting portions 4, and a pair of holder-side elastic locking portions 5. The holder body 2 includes a tabular portion 8. The tabular portion 8 is shaped like a flat board, and the central opening 3 are formed in the tabular portion 8. The central opening 3 is an opening into which a quadrangularly shaped female connector 20 as illustrated in FIGS. 3 and 4 is inserted.

The holder-side elastic locking portions 5 are formed on right and left sides of the central opening 3, respectively. Each of the holder-side elastic locking portions 5 includes quadrangularly shaped flat arms 5a each projecting from the holder body 2 and also includes hooks 5b that are bent and turned around from respective flat arms 5a in the direction opposite to the central opening 3. Each flat arm 5a and the corresponding book 5b are shaped like a letter U together, and the rear end of the hook 5b is positioned close to the holder body 2. The hook 5b has elasticity. When pressure is applied to the hook 5b in the right-left direction that is orthogonal to a direction in which each holder-side elastic locking portion 5 protrudes (i.e., in the frontward direction), the hook elastically deforms in the direction in which the pressure applies to the hook 5b.

The connector holder 1 is mounted on a panel 30 illustrated in FIG. 5. The panel 30 is disposed, for example, on the right or left side surface of an image forming apparatus, such as an image copier, and connectors are mounted on the panel 30. The connectors are used to connect various peripheral apparatuses (to be described later) to the image forming apparatus (main apparatus). A quadrangularly shaped panel-opening 31 in which the connector holder 1 is to be installed is formed in the panel 30. The panel opening 31 is larger than the central opening 3 of the connector holder 1, and the size of the panel opening 31 is such that the edge of the panel opening 31 is positioned near a region of the tabular portion 8 that surrounds the central opening 3 in the connector holder 1.

The connector holder 1 is installed or mounted in the panel opening 31 in a manner described as follows. When a pair of the holder-side elastic locking portions 5 of the connector holder 1 are inserted into the panel opening 31, each of the hooks 5b of respective holder-side elastic locking portions 5 receives pressure from the edge of the panel opening 31, and the pressure causes each hook b to deform toward the central opening 3. As the connector holder 1 is inserted further into the panel opening 31, the deformation of the hook 5b increases. When the rear end of the hook 5b passes through the panel opening 31, the hook 5b recover elastically from deformation in a direction opposite to the central opening 3 and thereby engages with the edge of the panel opening 31. Thus, the connector holder 1 is attached to the edge of the panel opening 31.

The holder-side elastic locking portions 5 of the connector holder 1 and the panel opening 31 are configured to be engageable with each other.

The connector holder 1 includes a pair of the abutting portions 4 that protrude frontward from the upper and lower ends of the holder body 2, respectively. A pair of the abutting portions 4 serve to suppress wobbling and enable the connector holder 1 to be mounted firmly on the edge of the panel opening 31. When the holder-side elastic locking portions 5 engage with the edge of the panel opening 31, the top ends of the abutting portions 4 abut the back side (rear surface) of the panel 30. The panel 30 is thereby pinched in the front-rear direction between the abutting portions 4 and the hooks 5b of the holder-side elastic locking portions 5.

Next, structures of the female connector 20 and the connector holder 1 that engage with each other will be described. The structure of the female connector 20 will be described first.

As illustrated in FIGS. 3 and 4, the female connector 20 (otherwise called the “connector 20”) includes a terminal portion 22 in a connector body 21, and the terminal portion 22 has 12 female terminals for electrical connection that are arranged in a three-column by four-row array. The terminal portion 22 is formed quadrangularly so as to be insertable into the central opening 3 of the connector holder.

As illustrated, connector-side elastic locking portions 24 are formed at respective right and left sides of the connector body 21 of the female connector 20. The connector-side elastic locking portions 24 have respective arms 24a and corresponding hooks 24b formed at the ends of the arms 24a. The arms 24a protrude from the rear end of the connector body 21 in the right and left directions and then extend horizontally frontward (toward the front surface of the terminal portion 22). Accordingly, the arms 24a are each shaped like a letter L. The hooks 24b are formed at corresponding ends of the arms 24a. The arms 24a have elasticity. When each arm 24a receives pressure applying in a direction toward the center of the connector body 21, the arm 24a deforms in this direction. Each hook 24b is shaped like an arrowhead having an inclined surface that extends backward from the front edge so as to become gradually distant from the connector body 21.

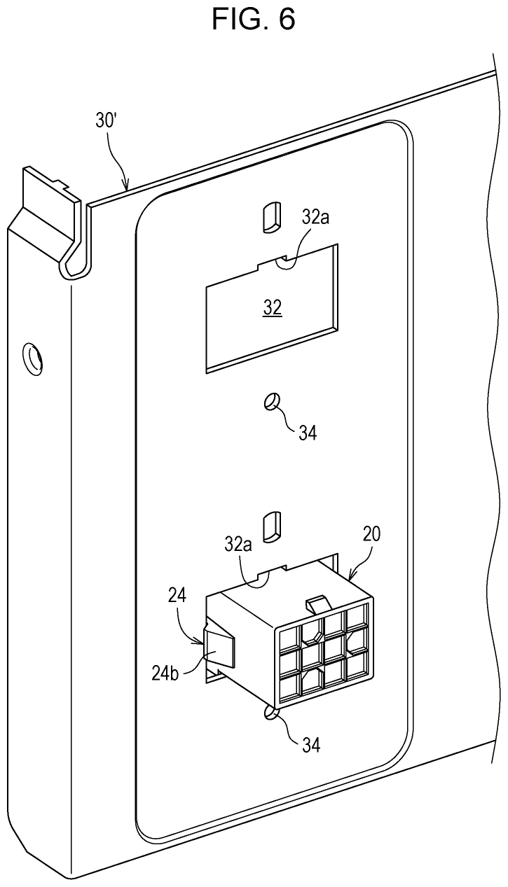

As illustrated in FIG. 6, the connector-side elastic locking portions 24 of the female connector 20 may engage with a small panel-opening 32 (another type of panel opening) of a panel 30′, which is different from the panel opening 31 having a large opening. In other words, the female connector 20 may be configured to be engageable with the small panel-opening 32 of the panel 3′. In such a case, the female connector 20 can be directly mounted in the small panel-opening 32 of the panel 30′.

In other words, as illustrated in FIG. 6, when the arms 24a of respective connector-side elastic locking portions 24 are inserted into the small panel-opening 32 of the panel 30′, the arms 24a and the hooks 24b receive pressure from the edge of the small panel-opening 32, and the pressure causes the arms 24a and the hooks 24b to deform toward the center of the connector body 21i. When the rear ends of the hooks 24b pass through the small panel-opening 32, the hooks 24b of the connector-side elastic locking portions 24 recover elastically from deformation and thereby engage with the edge of the small panel-opening 32. Thus, the female connector 20 is mounted on the edge of the small panel-opening 32.

However, the female connector 20 and the panel opening 31 of the panel 30 (otherwise called the “large panel-opening”) are not engageable with each other, and the female connector 20 cannot be mounted directly in the panel opening 31. Accordingly, the connector holder 1 is structured so as to engage with the female connector 20.

More specifically, in the connector holder 1, connector engagement openings 10 are formed in the tabular portion 8 of the holder body 2 at respective positions on right and left sides where the holder-side elastic locking portions 5 are formed. The connector-side elastic locking portions 24 of the female connector 20 are insertable in respective connector engagement openings 10.

Moreover, elastic locking portion openings 9a and 9b are formed in respective holder-side elastic locking portions 5 of the connector holder 1. The elastic locking portion openings 9a and 9b are formed through respective flat arms 5a and hooks 5b of the holder-side elastic locking portions 5 so as to continue to the connector engagement openings 10. This enables the connector-side elastic locking portions 24 of the female connector 20 to pass the connector engagement openings 10 and to be inserted further frontward into respective elastic locking portion openings 9a and 9b.

When the connector-side elastic locking portions 24 of the female connector 20 are inserted into the connector engagement openings 10 of the connector holder 1 and further into the elastic locking portion openings 9a and 9b, the arms 24a and hooks 24b receive pressure from the edges of the connector engagement openings 10 and thereby deform in directions toward the center of the connector body 21. When the rear ends of the hooks 24b pass the connector engagement openings 10 of tabular portion 8 of the connector holder 1, the hooks 24b recover elastically from deformation and engage with respective edges of connector engagement openings 10 of the tabular portion 8. Thus, the female connector 20 is mounted on the edges of connector engagement openings 10 of the connector holder 1. As described above, the connector-side elastic locking portions 24 of the female connector 20 and corresponding connector engagement openings 10 of tabular portion 8 of the connector holder 1 are configured to be engageable with each other.

When the connector-side elastic locking portion 24 of the female connector 20 engage with the edges of connector engagement openings 10 of tabular portion 8 of the connector holder 1, the edges of the connector engagement openings 10 serve as holder-side engagement portions 15 that engage with the hooks 24b of connector-side elastic locking portions 24 of the female connector 20.

Step portions 27 are formed in a rear portion of the female connector 20, and thereby the female connector 20 cannot move frontward along the arms 24a when the female connector 20 is mounted on the connector holder 1. As illustrated in FIGS. 3 and 4, the step portions 27 are formed in the rear portion of the connector body 21 at respective four side edges thereof. The step portions 27 each protrude upward or downward from the connector body 21. The step portions 27 are configured such that the front ends of the step portions 27 pinch the tabular portion 8 of the connector holder 1 with the rear ends of hooks 24b of the connector-side elastic locking portions 24, which causes the female connector 20 to be mounted firmly on the connector holder 1 without allowing the female connector 20 to wobble.

In the female connector 20, the length from the front surface of the terminal portion 22 to each rear end of hooks 24b of the connector-side elastic locking portions 24 is set equal to the front-rear length of each flat arm 5a of holder-side elastic locking portion 5 of the connector holder 1. Because of this, the front surface of terminal portion 22 of the female connector 20 is flush with (on the same surface of) the front ends 5c of flat arms 5a of the connector holder 1 in the state in which the connector-side elastic locking portions 24 of the female connector 20 elastically engage with the holder-side engagement portions 15 of the connector holder 1.

When the connector holder 1 is in the state in which the holder-side elastic locking portions 5 elastically engage with the large panel-opening 31 of the panel 30, in other words, in the state in which the connector holder 1 is mounted in the large panel-opening 31, an inner region of the tabular portion 8 (i.e., a region surrounding the central opening 3) is located inside the large panel-opening 31, in other words, located at a position between the edge of the large panel-opening 31 and the edge of the central opening 3 of the connector holder 1. Accordingly, in the state in which the connector holder 1 is mounted in the large panel-opening 31, when the female connector 20 is mounted in the central opening 3 of the connector holder 1, the tabular portion 8 covers a space between the edge of the large panel-opening 31 and the edge of the central opening 3.

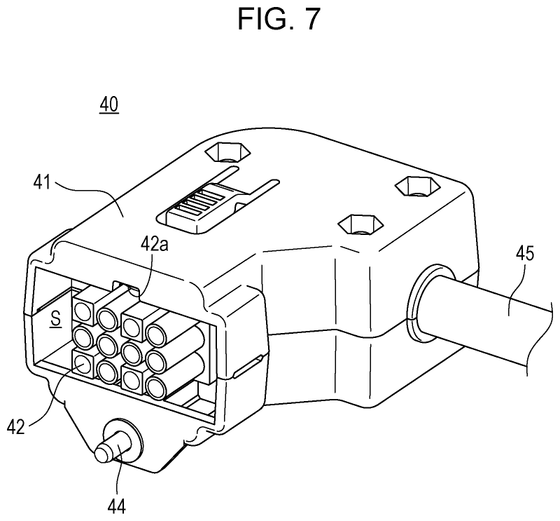

FIG. 7 is a view illustrating a male connector 40 configured to be connected to the female connector 20. The male connector 40 is a connector used, for example, for connection between an image forming apparatus (electronic apparatus), such as an image copier, and a peripheral apparatus. The peripheral apparatus includes, for example, an auto document feeder or a post-processing apparatus. The auto document feeder is an apparatus that allows a number of documents to be placed on a document tray thereof and automatically feeds the documents one by one to a document platen of the image forming apparatus (main apparatus). The post-processing apparatus is an apparatus that receives sheets of paper on which the main apparatus has formed images, performs post-processing, such as stapling, folding, or punching, and completes copying by discharging final copy products onto appropriate trays. The auto document feeder has a plurality of sensors for confirming the state of a document being conveyed, and the post-processing apparatus also has a plurality of sensors for confirming whether sheets are post-processed (i.e., stapled, punched, or the like) appropriately. The peripheral apparatuses such as auto document feeder and the post-processing apparatus each include a central processing unit (CPU) that controls a predetermined type of processing independently. While these CPUs communicate with a CPU included in the main apparatus via the female connector 20 and the male connector 40, these apparatuses operate in collaboration with each other. Note that the apparatuses described above are merely examples. The main apparatus is not limited to the image forming apparatus, and the peripheral apparatus is not limited to the auto document feeder nor to the post-processing apparatus.

Similarly to the female connector 20, the male connector 40 includes a quadrangularly shaped terminal portion 42 in a body 41 thereof, and the terminal portion 42 has 12 male terminals for electrical connection, which are arranged in a three-column by four-row array. The male connector 40 and the female connector 20 are connected with each other by inserting the terminal portion 42 into the terminal portion 22 of the female connector 20 with the male terminals being coupled to corresponding female terminals. A space S is formed around the terminal portion 42 inside the body 41 of the male connector 40. The space S is used to accommodate a pair of the holder-side elastic locking portions 5 of the connector holder 1 when the male connector 40 is connected to the female connector 20 while the female connector 20 is mounted on the connector holder 1. The male terminals of the terminal portion 42 are connected to a cable 45.

A notch 42a is formed in the male connector 40 at a position in a circumferential portion surrounding the space S. The notch 42a is provided for aligning the male connector 40 with the terminal portion 22 of the female connector 20. As illustrated in FIG. 3, the terminal portion 22 of the female connector 20 has a corresponding protrusion 26 that is formed at a center position in an upper region thereof so as to be insertabie into the notch 42a. Moreover, as illustrated in FIGS. 1 and 2, the holder body 2 of the connector holder 1 has a notch 3a at an upper central position in the edge of the central opening 3, and the protrusion 26 of the female connector 20 is insertable into the notch 3a.

In addition, a pin 44 protrudes from the male connector 40. The pin 44 is used for aligning the male connector 40 with the large-panel opening 31. As illustrated in FIG. 5, the panel 30 has a coupling hole 34 that is formed for engaging with the pin 44 at a position corresponding to the pin 44 of the male connector 40.

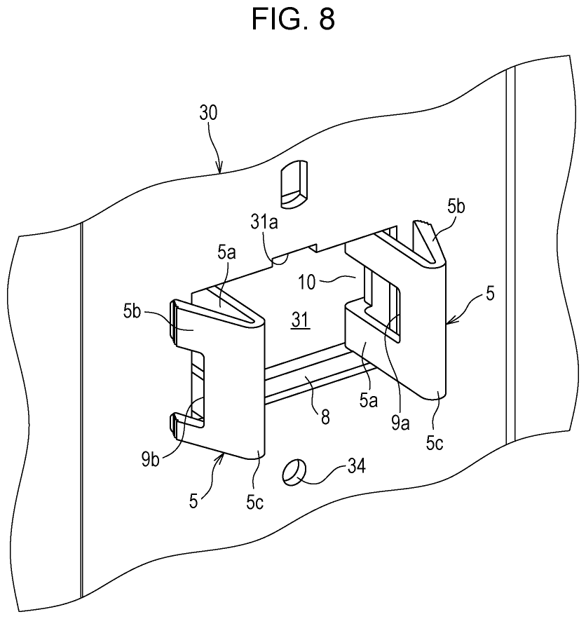

FIG. 8 is a perspective view illustrating the state in which the connector holder 1 is installed in the panel 30. When the connector holder 1 is mounted on the panel 30, the connector holder 1 is first placed behind the panel 30, and subsequently a pair of the holder-side elastic locking portions 5 of the connector holder 1 are inserted frontward into the large-panel opening 31. Meanwhile, the hooks 5b of the holder-side elastic locking portions 5 are caused to deform elastically toward the center of holder body 2 by the edge of the large panel-opening 31. When the rear ends of hooks 5b of the holder-side elastic locking portions 5 pass through the large panel-opening 31, the hooks 5b return elastically from deformation and engage with the edge of the large panel-opening 31. Thus, the connector holder 1 is mounted on the panel 30. At this time, a pair of the abutting portions 4 of the connector holder 1 about the rear surface of the panel 30, and the rear ends of the hooks 5b engage with the front surface of the panel 30. The connector holder 1 is thereby mounted reliably on the panel 30.

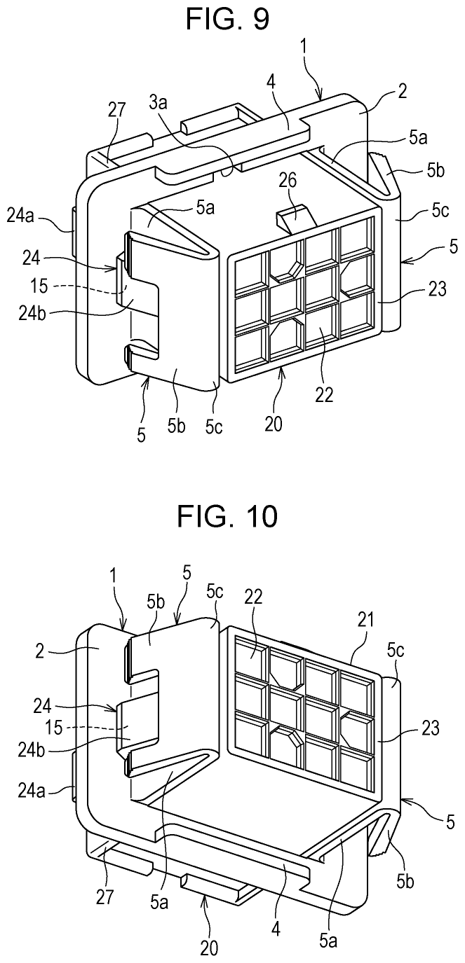

FIG. 9 is a perspective view that is viewed obliquely from above and illustrates the state in which the female connector 20 is mounted on the connector holder 1 that is mounted on the panel 30. FIG. 10 is a perspective view illustrating the same state as viewed obliquely from below. In FIGS. 9 and 10, the panel 30 is omitted in order to provide a clear view of the female connector 20 mounted on the connector holder 1.

As illustrated in FIGS. 9 and 10, when the female connector 20 is mounted on the connector holder 1, the female connector 20 is first placed behind the connector holder 1, and subsequently the female connector 20 is inserted frontward into the central opening 3 of the connector holder 1. The insertion direction of the female connector 20 is the same as the direction in which the connector holder 1 is inserted into the large panel-opening 31 (in the frontward direction).

While the protrusion 26 of the female connector 20 is inserted in the notch 3a of the connector holder 1, the connector body 21 of the female connector 20 is inserted into the central opening 3 of the connector holder 1. Subsequently, the connector-side elastic locking portions 24 of the female connector 20 are inserted into corresponding connector engagement openings 10 formed in the tabular portion 8 of the connector holder 1. The female connector 20 is inserted further frontward into the connector holder 1 while the arms 24a and hooks 24b of the connector-side elastic locking portions 24 deform toward the center of the connector body 21. When the rear ends of the hooks 24b of the connector-side elastic locking portions 24 pass respective connector engagement openings 10 of tabular portion 8 of the connector holder 1, the hooks 24b recover elastically from deformation and engage with respective holder-side engagement portions 15 of tabular portion 8 of the connector holder 1. The female connector 20 and the connector holder 1 enter the engagement state in which the tabular portion 8 of the connector holder 1 is interposed between the hooks 24b and the step portions 27 of the female connector 20. In the engagement state, the front surface of the terminal portion 22 of the female connector 20 is flush with the front edges 5c of holder-side elastic locking portions 5 of the connector holder 1.

The male connector 40 is subsequently connected to the female connector 20 in the state in which the female connector 20 is mounted on the connector holder 1 that is also mounted on the panel 30. In this case, while the pin 44 of the male connector 40 is inserted into the coupling hole 34 of the panel 30 for alignment, the protrusion 26 of the female connector 20 is inserted into the notch 42a of the male connector 40, and the terminal portion 42 of the male connector 40 are inserted into the terminal portion 22 of the female connector 20. At this time, the terminal portion 22 of the female connector 20 and a pair of the holder-side elastic locking portions 5 of the connector holder 1 are accommodated in the space S in the male connector 40.

In the present embodiment, in the case in which a small-size female connector 20 is mounted in the large panel-opening 31, the connector holder 1 is used if the female connector 20 is not compatible with the large panel-opening 31 in size or the like. The connector holder 1 is first mounted in the large panel-opening 31 by fitting the holder-side elastic locking portions 5 of the connector holder 1 onto the edge of the large panel-opening 31 by using elastic deformation. Subsequently, the female connector 20 is mounted on the connector holder 1 by fitting a pair of the connector-side elastic locking portions 24 of the female connector 20 onto a pair of the holder-side engagement portions 15 by using elastic deformation. Thus, the connector holder 1 enables the female connector 20 to be mounted in the large panel-opening 31.

For example, there may be a case in which an image forming apparatus (main apparatus) has a panel 30 as part of a body frame thereof and peripheral apparatuses are to be connected via connectors to the main apparatus. In such a case, even if male and female connectors for the peripheral apparatuses are changed to smaller ones, the connector holder 1 enables the small female connector 20 after the size change to be mounted in the large panel-openings 31. In the case in which the male and female connectors for the peripheral apparatuses are large before they are changed to smaller ones, the large size female connector before the size change can be mounted directly in the large panel-opening 31 without using the connector holder 1. Accordingly, it is sufficient to form single size panel-openings 31 in the body frame (panel 30) for the male and female connectors of the peripheral apparatuses whether or not the male and female connectors are changed to small ones. The large panel-opening 31 can accept the male and female connectors for the peripheral apparatuses irrespective of changing the size of connectors. Accordingly, it is not necessary to form different size openings in the body frame of the main apparatus in order to accept different size female connectors, and it is sufficient to manufacture panels 30 having single type panel openings 31. This leads to an improvement in versatility and also to price reduction.

When the female connector 20 is mounted on the connector holder 1, the female connector 20 is inserted into the central opening 3 of the connector holder 1 while the edges of connector engagement openings 10 of the tabular portion 8 causes the hooks 24b of connector-side elastic locking portions 24 of the female connector 20 to deform elastically. Subsequently, when the rear ends of the books 24b pass through the connector engagement openings 10, the hooks 24b recover elastically from deformation and engage with the holder-side engagement portions 15 of the connector holder 1. Thus, the engagement of the female connector 20 with the connector holder 1 is achieved due to elastic deformation of the connector-side elastic locking portions 24. Accordingly, during engagement, the connector-side elastic locking portions 24 are not subjected to an excess pressure that tends to act in the case of a conventional engagement structure where rigid components are connected with each other. As a result, the connector-side elastic locking portions 24 can maintain expected performance, enabling the female connector 20 to be mounted firmly on the connector holder 1 without allowing the female connector 20 to wobble.

In addition, as illustrated in FIG. 6, a pair of the connector-side elastic locking portions 24 of the female connector 20 can directly engage with the edge of the small panel-opening 32 of the panel 30′. In the present embodiment, the female connector 20 is mounted on the connector holder 1 by efficiently utilizing existing connector-side elastic locking portions 24 and fitting the connector-side elastic locking portions 24 onto the holder-side engagement portions 15 of the connector holder 1. Accordingly, it is not necessary to add a new elastic locking portion to a female connector 20 for the purpose of mounting on the connector holder 1. In other words, the existing female connector 20 can be directly mounted on the connector holder 1.

The connector holder 1 is formed such that the tabular portion 8 shaped like a flat board has the central opening 3 into which the female connector 20 can be inserted and also has the respective connector engagement openings 10 into which the connector-side elastic locking portions 24 of the female connector 20 can be inserted. In addition, the edges of the connector engagement openings 10 serve as the holder-side engagement portions 15. Accordingly, in engagement of the connector-side elastic locking portions 24 of the female connector 20 with the connector holder 1, it is not necessary to provide separate holder-side engagement portions 15, but instead the tabular portion 8 shaped like a flat board can be utilized efficiently for this purpose.

In the present embodiment, a pair of the holder-side elastic locking portions 5 are formed in respective right and left side portions on the connector holder 1, and holder-side engagement portions 15 are also formed in the same right and left side portions. Accordingly, the rigidity of the connector holder 1 is increased by the holder-side elastic locking portions 5 in the right and left side portions, and the holder-side engagement portions 15 are formed in the high rigidity portions. This contributes to a firm engagement, without wobbling, between the connector-side elastic locking portions 24 and the holder-side engagement portions 15 of the connector holder 1 when the female connector 20 is mounted on the connector holder 1.

In the connector holder 1, each of the holder-side elastic locking portions 5 and a corresponding one of the holder-side engagement t portions 15 are formed on the same right and left side portions, and the elastic locking portion openings 9a and 9b are formed in respective holder-side elastic locking portions 5. When the connector-side elastic locking portions 24 of the female connector 20 are inserted, into the connector engagement openings 10 toward the holder-side engagement portions 15, the elastic locking portion openings 9a and 9b allow the connector-side elastic locking portions 24 to engage with corresponding holder-side engagement portions 15 without the holder-side elastic locking portion 5 interfering with engagement of the hooks 24b of the connector-side elastic locking portions 24. This leads to easy and smooth engagement of the female connector 20.

In addition, in the present embodiment, when the connector holder 1 is mounted on the panel 30, the holder-side elastic locking portions 5 of the connector holder 1 are inserted into the large panel-opening 31 from behind the panel 30. When the female connector 20 is mounted on the connector holder 1, the connector-side elastic locking portions 24 of the female connector 20 are inserted into the connector engagement openings 10 and the holder-side engagement portions 15 from behind the connector holder 1. In other words, the direction of an engagement operation to cause the holder-side elastic locking portions 5 of the connector holder 1 to engage with the large panel-opening 31 is the same as the direction of an engagement operation to cause the connector-side elastic locking portions 24 of the female connector 20 to engage with the holder-side engagement portions 15 of the connector holder 1. This simplifies mounting of the female connector 20 onto the connector holder 1 and mounting of the connector holder 1 onto the panel 30.

Moreover, when the connector holder 1 is mounted on the panel 30, an inner region 16 on the tabular portion 8 of the connector holder 1, in other words, a region on the tabular portion 8 that surrounds the central opening 3 into which the female connector 20 is inserted, is located at a position between the edge of the large panel-opening 31 and the edge of the central opening 3 of the connector holder 1. Accordingly, even in the case in which a small size female connector 20 is installed in the large panel-opening 31 by using the connector holder 1, the inner region 16 of the tabular portion 8 covers the space between the edge of the large panel-opening 31 and the edge of the central opening 3 and thereby covers a region behind the panel 30. In this state, the female connector 20 can be mounted on the connector holder 1.

In the present embodiment, the front surface of terminal portion 22 of the female connector 20 is flush with the front ends of holder-side elastic locking portions 5 of the connector holder 1 in the state in which the female connector 20 engages with the connector holder 1, in other words, in the state in which the connector-side elastic locking portions 24 of the female connector 20 engage with the holder-side engagement portions 15 of the connector holder 1. Accordingly, when the male connector 40 is connected with the female connector 20, the holder-side elastic locking portions 5 do not interfere with a connection operation by which the terminal portion 22 of the female connector 20 is inserted into the terminal portion 42 and the space S of the male connector 40 and is connected with the terminal portion 42 of the male connector 40. This enables reliable connection between the terminal portion 22 and the terminal portion 42. Note that in order to avoid interference by the holder-side elastic locking portions 5 of the connector holder 1 when the female connector 20 is inserted, it is sufficient that the front ends of the holder-side elastic locking portions 5 are positioned at least rearward of the front surface of the terminal portion 22 of the female connector 20 (at positions closer to the rear end of the female connector 20).

### Second Embodiment

In the first embodiment, both the holder-side elastic locking portions 5 and holder-side engagement portions 15 are disposed on respective right and left portions on the connector holder 1. As in the second embodiment, however, either the holder-side elastic locking portions 5 or the holder-side engagement portions 15 may be disposed on respective paper and lower portions on the connector holder 1.

### Third Embodiment

In the previous embodiments, it is described that the female connector 20 is mounted on the connector holder 1. As in the third embodiment, however, the configurations of the female connector 20 and the male connector 40 may be switched with each other, and the male connector 40 may be mounted on the connector holder 1.

The present disclosure may be implemented in various other forms without departing from the spirit or the major features thereof. Accordingly, the embodiments described above are merely examples, and the scope of the present disclosure should not be limited to those described in the embodiments.

The connector holder described in the present disclosure enables a connector to be mounted on a panel without causing damage or deformation of the connector and the connector holder even if the connector is not compatible in size or the like with the panel on which the connector is mounted. The connector holder is usefully applied to electronic apparatuses having the panel for connectors.

The present disclosure contains subject matter related to that disclosed in Japanese Priori ty Patent Application No. 2018-134874 filed in the Japan Patent Office on Jul. 18, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A connector holder for detachably holding a connector, the connector holder comprising:
a holder-side elastic locking portion configured to deform elastically and thereby engage with a panel opening formed in a panel; and
a holder-side engagement portion configured to be engaged by a connector-side elastic locking portion of the connector while the connector-side elastic locking portion deforms elastically.

2. The connector holder according to claim 1, wherein
the connector-side elastic locking portion of the connector is configured to deform elastically and thereby be engageable, without using the connector holder, with another panel opening that is different in size from the panel opening formed in the panel.

3. The connector holder according to claim 1, further comprising:
a tabular portion through which a connector engagement opening is formed, wherein
the tabular portion has a holder-side engagement portion adjacent to the connector engagement opening, and the connector-side elastic locking portion is inserted into the connector engagement opening and thereby engages with the holder-side engagement portion.

4. The connector holder according to claim 1, wherein
the holder-side elastic locking portion is disposed in a side portion on the connector holder, and
the holder-side engagement portion is disposed in the same side portion on the connector holder as the side portion in which the holder-side elastic locking portion is disposed.

5. The connector holder according to claim 4, wherein
an elastic locking portion opening is formed in the holder-side elastic locking portion, the elastic locking portion opening allowing the connector-side elastic locking portion to engage with the holder-side engagement portion.

6. The connector holder according to claim 1, wherein
a direction of an engagement operation to cause the holder-side elastic locking portion to engage with the panel opening is the same as a direction of an engagement operation to cause the connector-side elastic locking portion to engage with the holder-side engagement portion.

7. The connector holder according to claim 1, wherein
the tabular portion is positioned inside the panel opening in a state in which the holder-side elastic locking portion engages with the panel opening.

8. The connector holder according to claim 1, wherein
in a state in which the connector-side elastic locking portion engages with the holder-side engagement portion, a front end of the holder-side elastic locking portion is located at a position being flush with a front end of the connector or at a position being closer to a rear end of the connector than the front end of the connector.

9. An electronic apparatus, comprising:
the connector holder according to claim 1;
a panel in which a panel opening is formed, wherein
the holder-side elastic locking portion of the connector holder deforms elastically and engages with the panel opening.
